(19) United States
(12) Patent Application Publication
(10) Pub. No.: US 2024/0299846 A1
(43) Pub. Date: Sep. 12, 2024

(54) INFORMATION PROCESSING DEVICE, SYSTEM, INFORMATION PROCESSING METHOD, AND INFORMATION PROCESSING PROGRAM

(71) Applicants: Sony Interactive Entertainment Inc., Tokyo (JP); Sony Interactive Entertainment LLC, San Mateo, CA (US)

(72) Inventors: Kohki TACHIHARA, Chiba (JP); Emiko HORIKAWA, Tokyo (JP); Yoshihiko HIRAKAWA, Tokyo (JP); Naoki HATANO, Saitama (JP); Ling XIE, Foster City, CA (US); Takuya KAWASAKI, Tokyo (JP)

(73) Assignees: Sony Interactive Entertainment Inc., Tokyo (JP); Sony Interactive Entertainment LLC, San Mateo, CA (US)

(21) Appl. No.: 18/588,793

(22) Filed: Feb. 27, 2024

Related U.S. Application Data
(60) Provisional application No. 63/488,789, filed on Mar. 7, 2023.

(51) Int. Cl. A63F 13/46; A63F 13/24; A63F 13/211; A63F 13/214

(52) U.S. Cl. CPC A63F 13/46; A63F 13/24; A63F 13/211; A63F 13/214

(57) ABSTRACT

Disclosed herein is an information processing device including at least one memory for storing a program code, and at least one processor for executing an operation by processing the program code, in which the operation includes obtaining information indicating a detection result according to an operation device that includes a detection section that detects an operation by a user, and calculating, on a basis of at least one of a type of the operation, the number of times for the operation, and an amount of execution time for the operation, points to be redeemed by a user.

### CROSS REFERENCE TO RELATED APPLICATIONS

This application claims priority to a U.S. Provisional Application, Ser. No. 63/488,789, filed on Mar. 7, 2023, which is herein incorporated by reference in its entirety.

### BACKGROUND

The present disclosure pertains to an information processing device, a system, an information processing method, and a program.

In the past, there is known an operation device that is used as an input device for an information processing device that can execute a game program, reproduce a video, and execute, inter alia, communication of information via the internet (for example, refer to US Patent Application Publication No. 2015/0193017).

In the present disclosure described in US Patent Application Publication No. 2015/0193017, an operation device transmits a signal that correspond to an operation by a user to an information processing device by wire or wirelessly. The operation device includes an operation button, directional keys, and a touch panel, and incorporates various sensors that are used to detect motion by and the orientation of the operation device.

### SUMMARY

It is desirable to increase opportunities for coming into contact with an operation device such as a controller, and to improve a frequency of using an information processing device that is operated by the operation device.

According to a first aspect of the present disclosure, there is provided an information processing device including at least one memory for storing a program code and at least one processor for executing an operation by processing the program code. The operation includes obtaining information indicating a detection result according to an operation device that includes a detection section that detects an operation by a user, and calculating, on the basis of at least one of a type of the operation, the number of times for the operation, and an amount of execution time for the operation, points to be redeemed by a user.

According to a second aspect of the present disclosure, there is provided a system including an operation device that accepts an operation by a user, and an information processing device. The operation device includes at least one memory for storing a program code and at least one processor for execution an operation by processing the program code, and the operation including detecting the operation, calculating, on the basis of at least one of a type of the operation, the number of times for the operation, and an amount of execution time for the operation, points to be redeemed by a user, and transmitting information indicating the points to the information processing device.

According to a third aspect of the present disclosure, there is provided an information processing method that is performed by an information terminal connected to an operation device that includes a detection section and accepts an operation by a user. By an operation that at least one processor executes according to a program code stored in at least one memory, the method includes obtaining information indicating a detection result by the detection section, and a point calculation procedure for calculating, on the basis of at least one of a type of the operation, the number of times for the operation, and an amount of execution time for the operation, points to be redeemed by a user.

According to a fourth aspect of the present disclosure, there is provided a program that is executed by an information terminal connected to an operation device that includes a detection section and accepts an operation by a user. An operation that at least one processor executes in accordance with the program includes according to the information terminal, obtaining information indicating a detection result by the detection section, and calculating, on the basis of at least one of a type of the operation, the number of times for the operation, and an amount of execution time for the operation, points to be redeemed by a user.

### BRIEF DESCRIPTION OF THE DRAWINGS

FIG. 1 is a schematic view for illustrating a schematic configuration of an information processing system according to a first embodiment;

FIG. 2 is a view for describing in relation to a calculation section according to the first embodiment;

FIG. 3 is a view for describing in relation to a character generation section according to the first embodiment;

FIG. 4 is a different view for describing in relation to a character generation section according to the first embodiment;

FIG. 5 is a flow chart for illustrating an example of a processing method according to the first embodiment;

FIG. 6 is a different flow chart for illustrating an example of a processing method according to the first embodiment;

FIG. 7 is a different flow chart for illustrating an example of a processing method according to the first embodiment;

FIG. 8 is a schematic view for illustrating a schematic configuration of an information processing system according to a second embodiment; and

FIG. 9 is a schematic view for illustrating a schematic configuration of an information processing system according to a third embodiment.

### DETAILED DESCRIPTION OF THE PREFERRED EMBODIMENTS

### First Embodiment

Description is given below regarding a first embodiment of the present disclosure, on the basis of the drawings.

### [Schematic Configuration of Information Processing System]

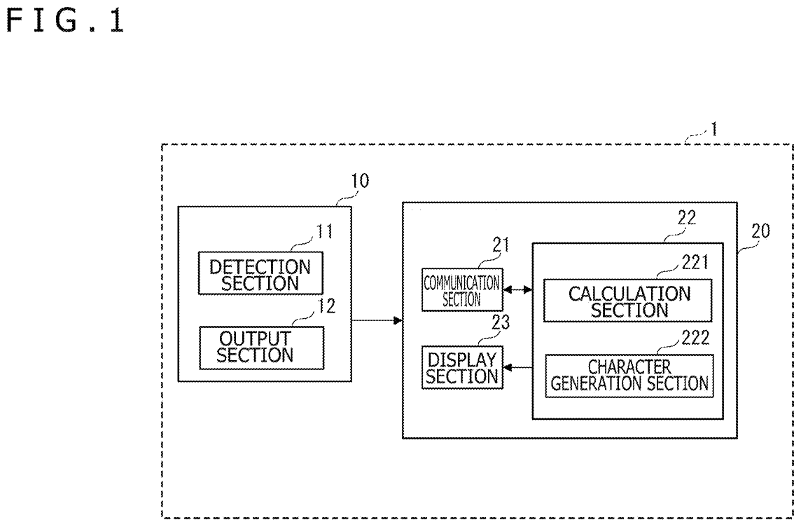

FIG. 1 is a schematic view that illustrates a schematic configuration of an information processing system according to a first embodiment.

As illustrated in FIG. 1, an information processing system 1 according to the first embodiment includes an operation device 10 and an information processing device 20. The information processing system 1 is a game system, for example, and the information processing device 20 is configured by a computer or game device that executes a game in response to an operation with respect to the operation device 10.

### [Configuration of Operation Device]

The operation device 10 includes a detection section 11 and an output section 12, and accepts an operation by a user. The detection section 11 detects an operation by a user with respect to an operation piece that is not illustrated. The output section 12 outputs, wirelessly or by wire, a detection result from the detection section 11 to outside of the operation device 10.

For example, a controller, a keyboard, a mouse, a touch panel, or the like may be given as the operation device 10.

The detection section 11 detects, as an operation with respect to the operation device 10, at least one of the type of an operation piece used in the operation, an operation direction for the operation piece, and an operation angle for the operation piece.

For example, in a case where the operation device 10 is a controller that includes a plurality of operation pieces, the detection section 11 detects the presence or absence of an operation with respect to an operation piece belonging to the controller, or an operation angle and operation direction for the operation piece. The controller may have any configuration. For example, it may be a controller that includes buttons and directional keys, or it may be a controller that includes a stick that can be tilted.

In addition, in a case where the operation device 10 is a keyboard, for example, the detection section 11 detects the presence or absence of pressing with respect to operation pieces that are each key on the keyboard.

In addition, in a case where the operation device 10 is a mouse, for example, the detection section 11 detects an operation direction and operation angle according to the mouse body, or the presence or absence of an operation with respect to each operation piece provided on the mouse, and an operation direction and operation angle for an operation piece.

In addition, for example, in a case where the operation device 10 is a touch panel, for example, the detection section 11 detects a contact position with respect to the touch panel as well as a direction and an angle for when the contact position changes.

The output section 12 outputs the above-described detection results by the detection section 11 to outside of the operation device 10.

### [Configuration of Information Processing Device]

As illustrated in FIG. 1, the information processing device 20 includes a communication section 21, a control section 22, and a display section 23.

The communication section 21 receives a detection result that is by the detection section 11 and is outputted from the output section 12 in the operation device 10. The detection result by the detection section 11 is used as information for various types of processing in the information processing device 20, and is also used to calculate points that are described below.

The control section 22 includes various functions for a character generation section 222 and a calculation section 221, which are implemented by a signal processing circuit in which at least one processor executes an operation in accordance with a program code that is stored in a memory or received via a communication interface. Description is given below regarding the functionality of each section.

The display section 23 includes an LCD (liquid crystal display) display element, an organic EL (electroluminescence) display element, or the like, for example, and can display a display image to thereby present the display image to a user. Note that that display section 23 may be provided independent from the information processing device 20, or may be a display section in an HMD (head mounted display) unit.

Next, description is given regarding functionality of each section in the control section 22 in the information processing device 20.

The calculation section 221 calculates, on the basis of a detection result that is by the detection section 11 and is received via the communication section 21, points to be redeemed by a user.

For example, the calculation section 221 calculates the points on the basis of at least one of a type of operation at the operation device 10, the number of operations, and an amount of execution time for an operation.

For example, the calculation section 221 calculates points on the basis of a type of operation at the operation device 10, but, inter alia, a type of an operation piece used in an operation at the operation device 10, an operation direction for an operation piece, and an operation angle for an operation piece may be given as a type of operation, for example.

Regarding the type of an operation piece, the calculation section 221 may calculate a different number of points on the basis of the type of operation piece, for example, or may calculate a different type of points on the basis of the type of operation piece.

For example, in a case where the operation device 10 includes four press buttons A through D as operation pieces, the calculation section 221 may calculate points Px on the basis of the number of times that the A button is pressed or an amount of time that the A button is pressed and, for the B through D buttons, calculate points Px at a different redemption rate to that for the A button and on the basis of the number of times that each button is pressed or an amount of time in which each button is pressed, in other words setting a rate of redemption to points to mutually different values, whereby one type of points Px are calculated. By calculating points in this manner, it is possible to, on the basis of the type of an operation piece used in an operation, calculate points while changing a degree of influence that is reflected to the points.

In addition, the calculation section 221 may, for example, calculate points Pa on the basis of an amount of time that the A button is pressed or the number of times that the A button is pressed, and similarly calculate points Pb in relation to the B button, calculate points Pc in relation to the C button, and calculate points Pd in relation to the D button. By calculating points in this manner, it is possible to calculate a plurality of types of points on the basis of types of operation pieces used in operations.

Furthermore, a plurality of types of points may be calculated by combining the two types of calculation methods described above.

In addition, similarly regarding an operation direction for an operation piece, the calculation section 221 may calculate a different number of points on the basis of operation directions for operation pieces, for example, or may calculate a different type of points on the basis of the operation directions for operation pieces.

For example, in a case where the operation device 10 includes directional keys that can be operated in four directions E through H as operation pieces, the calculation section 221 may calculate points Py on the basis of an amount of time in which the operation direction is the E direction and, in a case where the operation direction is the F through H direction, respectively calculate points Py at a different redemption rate than that for the case where the operation direction is the E direction, in other words, set a rate of redemption to points to a mutually different value for each operation direction to thereby calculate one type of points Py. By calculating points in this manner, it is possible to, on the basis of the operation direction for an operation piece used in an operation, calculate points while changing a degree of influence that is reflected to the points.

In addition, the calculation section 221 may, for example, calculate points Pe on the basis of an amount of time that the operation direction is the E direction, and similarly calculate points Pf on the basis of an amount of time that the operation direction is the F direction, calculate points Pg on the basis of an amount of time that the operation direction is the G direction, and calculate points Ph on the basis of an amount of time that the operation direction is the H direction. By calculating points in this manner, it is possible to calculate a plurality of types of points on the basis of operation directions of operation pieces used in operations.

Furthermore, a plurality of types of points may be calculated by combining the two types of calculation methods described above.

In addition, similarly regarding an operation angle for an operation piece, the calculation section 221 may calculate a different number of points on the basis of operation angles for operation pieces, for example, or may calculate a different type of points on the basis of the operation angles for an operation piece.

For example, in a case where the operation device 10 includes, as an operation piece, an operation piece such as a stick or a dial that can be operated in any direction, the operation angle is divided in advance into a plurality of ranges, for example, I through K, and the calculation section 221 may calculate points Pz on the basis of an amount of time in which the operation angle is in the I range and, in a case where the operation direction is in the J range through the K range, calculate, on the basis of a respective amount of time, points Pz at a redemption rate different to the case where the operation direction is in the I range, in other words, set the rate of redemption to points to a mutually different values according to the operation angle, to thereby calculate one type of points Pz. By calculating points in this manner, it is possible to, on the basis of the operation angle for an operation piece used in an operation, calculate points while changing a degree of influence that is reflected to the points.

In addition, the calculation section 221, for example, may calculate points Pi on the basis of an amount of time in which the operation angle is in the I range, and similarly calculate points Pj on the basis of an amount of time in which the operation angle is in the J range, and calculate points Pk on the basis of an amount of time in which the operation angle is in the K range. By calculating points in this manner, it is possible to calculate a plurality of types of points on the basis of operation angles of an operation piece used in operations.

Furthermore, a plurality of types of points may be calculated by combining the two types of calculation methods described above.

Note that this similarly applies also to operation pieces other than each example described above.

For example, in a case where the operation device 10 includes an operation piece that enables a tilt amount to be adjusted, the calculation section 221 may calculate points on the basis of the tilt amount.

In addition, in a case where the operation device 10 is a keyboard, the calculation section 221 may calculate points on the basis of a type of key.

In addition, in a case where the operation device 10 is a mouse, the calculation section 221 may calculate points on the basis of, inter alia, an operation angle and operation direction according to a mouse body, or a type of each operation piece that the mouse is provided with.

In addition, for example, in a case where the operation device 10 is a touch panel, the calculation section 221 may calculate points on the basis of a contact position with respect to the touch panel as well as a direction and an angle for when the contact position changes.

In addition, in a case where the operation device 10 is itself provided with a gyro sensor and an acceleration sensor, the calculation section 221 may calculate points on the basis of a detection result by each sensor.

In addition, the calculation section 221 may determine the number of times for an operation on the basis of an amount of execution time for the operation. For example, when a generally-called long-push operation is performed, the calculation section 221 may determine the number of times for an operation in response to an amount of execution time for the operation, and calculate points on the basis of the determined number of times for the operation.

The calculation section 221 starts calculating points described thus far when the information processing device 20 activates or in response to an instruction by a user. The calculation section 221 calculates points as a background process in the information processing device 20. The calculated points are sequentially updated or accumulated, and are stored in a storage section that is not illustrated.

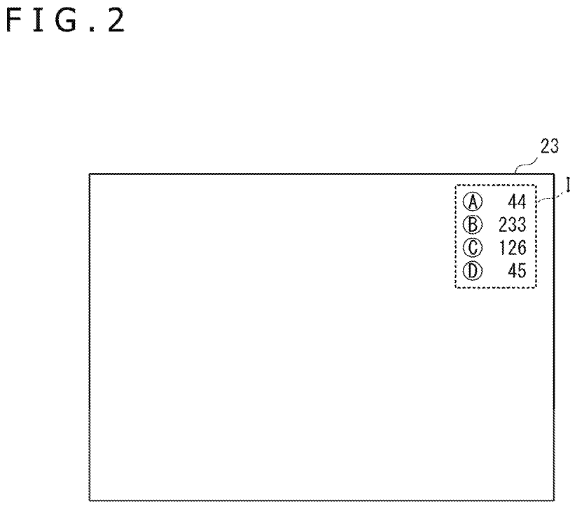

In addition, points calculated by the calculation section 221 may be able to be confirmed automatically or in response to an instruction by a user. For example, as illustrated in FIG. 2, a configuration may be taken to display information indicating calculated points on the display section 23 in the information processing device 20. Note that information I may be information that indicates the number of points or may be information that indicates details of an operation that is based on calculation of the number of points. In a case where the operation device 10 includes four press buttons A through D as operation pieces, the example in FIG. 2 illustrates an example in which information I that indicates the number of presses for each button is displayed.

The character generation section 222 generates a character according to points calculated by the calculation section 221. The character generation section 222 generates the character after determining, according to the points, the shape of the character, the number of characters, movement details for the character, and the like.

The character generation section 222 may generate characters having different shapes according to the number of points, for example. In this case, the character generation section 222 may compare the number of points with a predetermined threshold, and generate any character from among a plurality of predefined characters, or may generate a character having a size that corresponds to the number of points.

The character generation section 222 may generate the number of characters that differ according to the number of points, for example. In this case, the character generation section 222 generates more character the greater the number of points.

The character generation section 222 may generate characters having movement details that differ according to the number of points, for example. In this case, the character generation section 222 may generate a character having different movement details according to the number of points or may, the greater the number of points, generate a character having more movement details or having more complex movement details.

In addition, in a case where a plurality of types of points is calculated by the calculation section 221, the character generation section 222 may generate characters having shapes that differ according to the types of points, for example. In this case, the character generation section 222 generates any character from among a predefined plurality of characters, according to a type of points.

The character generation section 222 may generate the number of characters that differ according to types of points, for example. In this case, the character generation section 222 generates any character from among a predefined number of characters, according to a type of points.

In addition, the character generation section 222 may generate characters having movement details that differ according to a type of points, for example.

The character generation section 222 starts character generation, which is described thus far, in response to an instruction by a user or automatically.

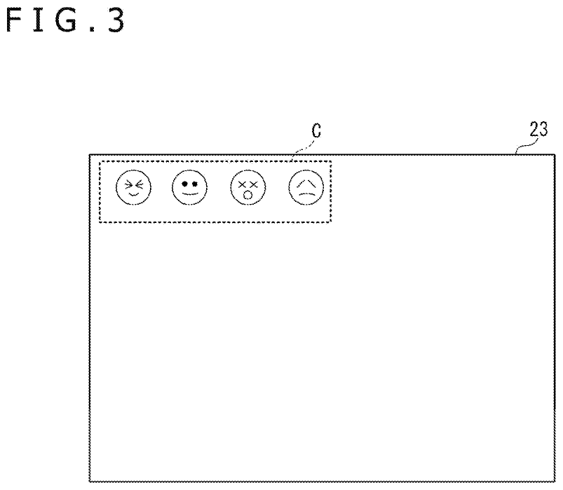

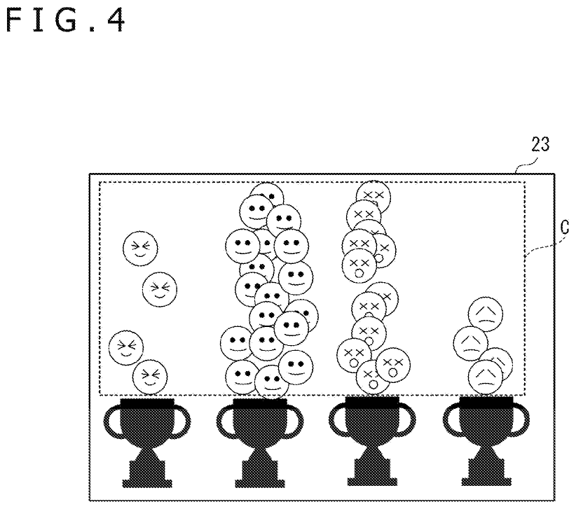

In addition, a character generated by the character generation section 222 may be displayed on the display section 23 in response to an instruction by a user, or automatically. For example, as illustrated by examples in FIG. 3 and FIG. 4, there may be a configuration in which generated characters C are displayed by the display section 23 belonging to the information processing device 20.

The example in FIG. 3 illustrates an example in which four different types of characters are generated and displayed one-by-one. In addition, the example in FIG. 4 illustrates an example in which four different types of characters are generated and displayed according to the number of points.

### [Flow of Information Processing]

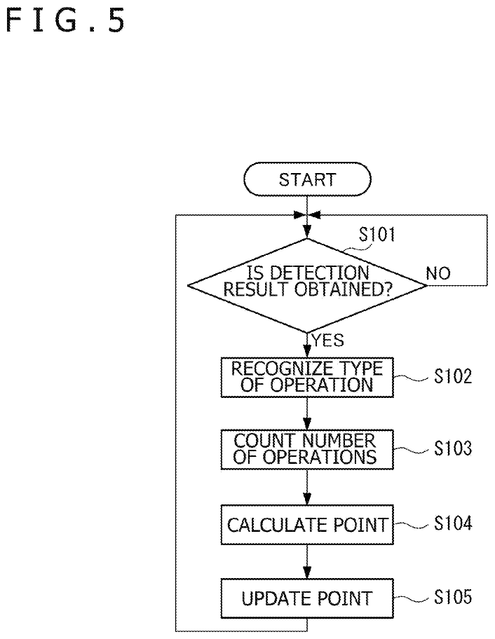

FIG. 5 is a flow chart that illustrates a process that is executed by the control section 22 when calculating points.

The control section 22 determines whether or not a detection result according to the operation device 10 has been obtained via the communication section 21 (step S101) and, when it is determined that a detection result has been obtained (YES in step S101), the calculation section 221 recognizes a type of operation (step S102) and counts the number of operations for each type of operation (step S103).

Furthermore, the calculation section 221 calculates the number of points (step S104) and, upon updating the number of points (step S105), returns to step S101.

In other words, each time a detection result according to the operation device 10 is obtained, processing for steps S102 through S105 are repeatedly executed. Accordingly, each time a detection result according to the operation device 10 is obtained, points are calculated and updated by the calculation section 221.

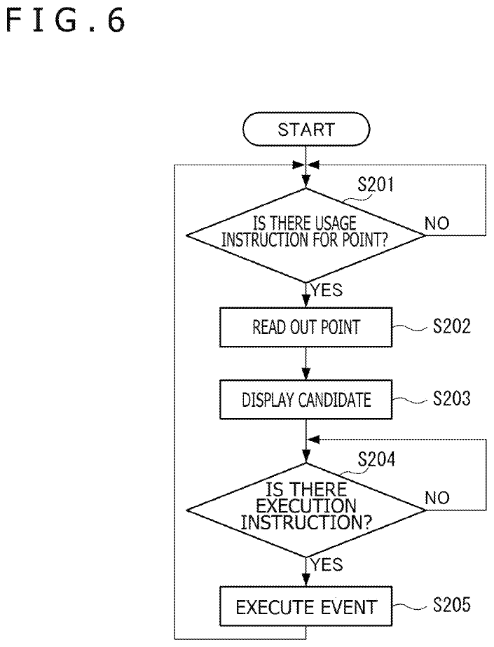

FIG. 6 is a flow chart that illustrates a process that is executed by the control section 22 when points are used. The example in FIG. 6 exemplifies a case of executing character generation in response to an instruction by a user.

The control section 22 determines whether or not a point usage instruction has been made by a user (step S201) and, upon determining that a point usage instruction has been made (YES in step S201), reads out points from the calculation section 221 (step S202), and displays a candidate on the display section 23 (step S203).

Here, a candidate is information indicating a character that can be generated according to points. As described above, the character generation section 222 generates a character according to the number of points and a type of points. Accordingly, the control section 22 displays, on the display section 23, a character that can be generated according to the number of points and type of points that are read out.

The control section 22 determines whether or not an instruction to execute has been made by a user (step S204) and, upon determining that an instruction to execute has been made (YES in step S204), executes an event (step S205), and returns to step S201. In the example in FIG. 5, an event is more specifically generation of a character by the character generation section 222.

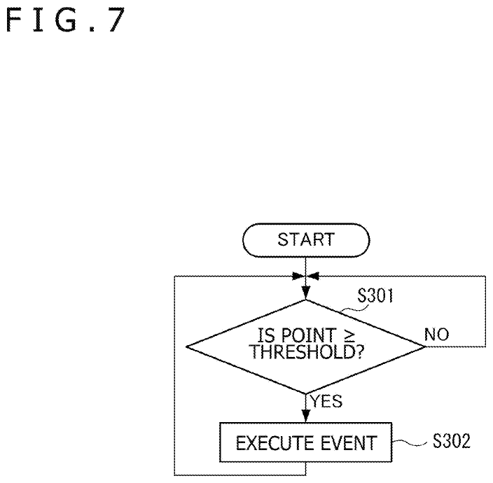

FIG. 7 is a flow chart that illustrates another process that is executed by the control section 22 when points are used. The example in FIG. 7 exemplifies a case of automatically executing character generation.

The control section 22 determines whether or not the number of points calculated by the calculation section 221 exceeds a predetermined threshold (step S301) and, when it is determined that the number of points exceeds the predetermined threshold (YES in step S301), the character generation section 222 executes an event according to the number of points and the type of points (step S302). In the example in FIG. 6, an event is more specifically generation of a character by the character generation section 222.

Note that the determination described in step S301 is assumed to be performed at a predetermined time interval. In addition, a condition for the determination described in step S301 may be determined according to details of points calculated by the calculation section 221. For example, in a case where a plurality of types of points is calculated by the calculation section 221, a threshold for the number of points may be provided for each type of points, or a threshold may be provided in relation to a total number of points without taking into account the types of points.

Furthermore, configuration may be such that a process in which character generation is executed in response to an instruction by a user as described in FIG. 6 and a process in which character generation is automatically executed as described in FIG. 7 are switchingly performed, or configuration may be such that only one of these is performed.

Switching between the two types of processes or selection of which process from among the two types of processes may be executed in response to an instruction by a user or may be executed according to a predetermined condition.

### Effect of First Embodiment

The information processing system 1 according to the first embodiment described above achieves the following effects.

The information processing device 20 obtains information indicating a detection result according to the operation device 10 that includes the detection section 11 that detects an operation by a user, and calculates, on the basis of at least one of a type of the operation, the number of times for the operation, and an amount of execution time for the operation, points to be redeemed by a user.

By virtue of such a configuration, it is possible to calculate points to be redeemed by a user according to details of an operation by a user with respect to an operation device. As a result, it is possible to provide additional value to the user at a time of usage of the operation device and an information device. Accordingly, it is possible to expect that opportunities for a user to come into contact with an operation device will be increased, and that a user will increase a frequency of using an information processing device that is operated by the operation device.

A type of operation includes at least one of the type of an operation piece used in the operation, an operation direction for the operation piece, and an operation angle for the operation piece.

By virtue of such a configuration, it is possible to calculate points that reflect operations by a user, according to the configuration of the operation device.

The calculation section 221 calculates a plurality of types of points that has different intended uses to one another. Accordingly, it is possible to calculate many kinds of points according to the configuration of an operation device.

The character generation section 222 generates a character according to points calculated by the calculation section 221, whereby it is possible for the points to be redeemed by the user. Accordingly, a user can obtain rewards such as generation of a character, and it is possible to expect the user's interest or curiosity with respect to the operation device or information processing device to be stimulated.

The character generation section 222, according to points, determines at least one of the shape of a character, the number of characters, and movement details for a character. Accordingly, characters change or develop according to points, and it is possible to expect the user's interest or curiosity to be further stimulated.

### Second Embodiment

With reference to the drawings, description is given below regarding a second embodiment of the present disclosure. In the second embodiment, description is given regarding only portions that differ from those in the first embodiment, and description regarding portions similar to those in the first embodiment is omitted. In addition, in the second embodiment, the same reference symbols are added to components having substantially the same functional configuration as those in the first embodiment.

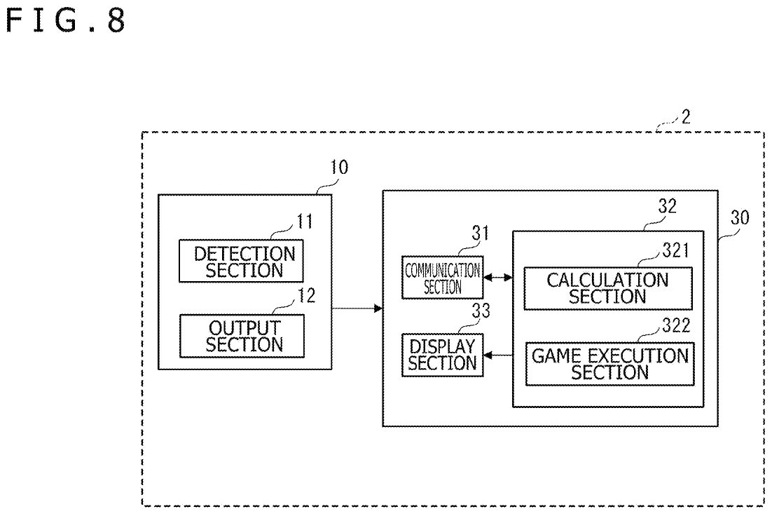

FIG. 8 is a schematic view that illustrates the entirety of an information processing system according to the second embodiment of the present disclosure.

As illustrated in FIG. 8, an information processing system 2 according to the second embodiment includes an information processing device 30 in place of the information processing device 20 in the information processing system 1 according to the first embodiment. Similarly to the information processing system 1 according to the first embodiment, the information processing system 2 is a game system, for example, and the information processing device 30 is configured by a computer or game device that executes a game in response to an operation with respect to the operation device 10.

### [Configuration of Information Processing Device 30]

As illustrated in FIG. 8, the information processing device 30 includes a communication section 31 and a display section 33, which are similar to the communication section 21 and the display section 23 in the first embodiment, and a control section 32.

The control section 32 includes various functions for a calculation section 321 and a game execution section 322, which are implemented by a signal processing circuit in which at least one processor executes an operation according to a program code that is stored in a memory or received via a communication interface. The calculation section 321 is similar to the calculation section 221 in the first embodiment.

The game execution section 322 executes a game according to points calculated by the calculation section 321. Here, a game can be played by using the points calculated by the calculation section 321.

For example, the game execution section 322 may be able to execute different games according to the number of points, or may determine, according to the number of points, a content that can be executed in a game. For example, the game execution section 322 may be configured to lengthen an amount of game execution time the greater the number of points or may be configured to increase a status and an experience value in the game the greater the number of points.

In addition, in a case where a plurality of types of points is calculated by the calculation section 321, for example, the game execution section 322 may enable execution of games of different types according to a point type, or may determine a content that can be executed in a game according to a point type.

The game execution section 322 starts execution of a game described thus for in response to an instruction by a user or automatically.

Note that the calculation section 321 may be configured to calculate additional points according to a result of game executed by the game execution section 322.

### [Flow of Information Processing]

In the second embodiment, the calculation section 321 in the information processing device 30 executes the point calculation process described with reference to the flow chart in FIG. 5 in the first embodiment. The control section 32 in the information processing device 30 executes a process for a point usage time that is described with reference to the flow charts in FIG. 6 and FIG. 7 in the first embodiment.

However, in the second embodiment, information that indicates a game that can be executed according to points and a content of the game are displayed on the display section 33 as a candidate in step S203 in FIG. 6.

In addition, in step S205 in FIG. 6 and step S302 in FIG. 7, an event is more specifically execution of a game by the game execution section 322.

### Effect of the Second Embodiment

The information processing system 2 according to the second embodiment described above achieves the following effects.

The game execution section 322 executes a game according to points calculated by the calculation section 321, whereby points can be redeemed by a user. Accordingly, a user can obtain rewards such as execution of a game, and it is possible to expect the user's interest or curiosity with respect to the operation device or information processing device to be stimulated.

### Third Embodiment

With reference to the drawings, description is given below regarding a third embodiment of the present disclosure. In the second embodiment, description is given regarding only portions that differ from those in the first embodiment, and description regarding portions similar to those in the first embodiment and second embodiment is omitted. In addition, in the third embodiment, the same reference symbols are added to components having substantially the same functional configuration as those in the first embodiment and the second embodiment.

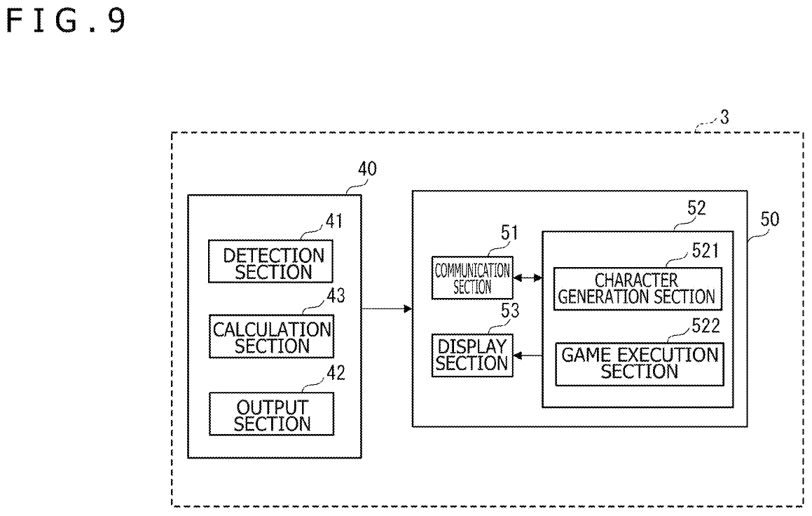

FIG. 9 is a schematic view that illustrates the entirety of an information processing system according to the third embodiment of the present disclosure.

As illustrated in FIG. 9, an information processing system 3 according to the third embodiment includes an operation device 40 and an information processing device 50 in place of the operation device 10 and the information processing device 20 in the information processing system 1 according to the first embodiment. Similarly to the information processing system 1 according to the first embodiment and the information processing system 2 according to the second embodiment, the information processing system 3 is a game system, for example, and the information processing device 50 is configured by a computer or game device that executes a game in response to an operation with respect to the operation device 40.

### [Configuration of Operation Device 40]

As illustrated in FIG. 9, the operation device 40 includes a detection section 41, an output section 42, and a calculation section 43, and accepts an operation by a user. Similarly to the detection section 11 in the operation device 10 in the first embodiment and the second embodiment, the detection section 41 detects an operation by a user with respect to an operation piece that is not illustrated. Similarly to the output section 12 in the operation device 10 in the first embodiment and the second embodiment, the output section 42 outputs, by wire or wirelessly, a detection result by the detection section 41 to outside of the operation device 40. Furthermore, the output section 42 outputs information indicating points calculated by the calculation section 43 to outside of the operation device 40.

The calculation section 43 has a similar functional configuration to the calculation section 221 which is functionality provided to the control section 22 in the information processing device 20 in the information processing system 1 according to the first embodiment, and the calculation section 321 which is functionality provided to the control section 32 in the information processing device 30 in the information processing system 2 according to the second embodiment.

### [Configuration of Information Processing Device 50]

As illustrated in FIG. 9, the information processing device 50 includes a communication section 51, a control section 52, and a display section 53.

The communication section 51 receives a detection result that is by the detection section 41 and is outputted from the output section 42 in the operation device 40, and information indicating points calculated by the calculation section 43.

The control section 52 includes various functions for a character generation section 521 and a game execution section 522, which are implemented by a signal processing circuit in which at least one processor executes an operation according to a program code that is stored in a memory or received via a communication interface.

The character generation section 521 is similar to the character generation section 222 described in the first embodiment, and the game execution section 522 is similar to the game execution section 322 described in the second embodiment.

### [Flow of Information Processing]

In the third embodiment, the calculation section 43 in the operation device 40 executes the point calculation process described with reference to the flow chart in FIG. 5 in the first embodiment.

The control section 52 in the information processing device 50 executes a process for a point usage time that is described with reference to the flow charts in FIG. 6 and FIG. 7 in the first embodiment.

In other words, in the third embodiment, the point calculation process is executed on the operation device 40 side and the calculated points are supplied to the information processing device 50, whereby it is possible to use the points on the information processing device 50 side.

Note that, regarding usage of points, a process may be executed by only one of the character generation section 521 and the game execution section 522, or a process may be executed on both of the character generation section 521 and the game execution section 522. In the latter case, for example, a game may be executed in the game execution section 522 using a character generated by the character generation section 521.

### Effect of the Third Embodiment

The information processing system 3 according to the third embodiment described above achieves the following effects.

The information processing system 3 includes the operation device 40 that accepts an operation by a user and the information processing device 50, and the operation device 40 includes the detection section 41 that detects the operation, the calculation section 43 that calculates, on the basis of at least one of a type of the operation, the number of times for the operation, and an amount of execution time for the operation, points to be redeemed by a user, and the output section 42 that is a transmission section for transmitting information indicating points to the information processing device 50.

By virtue of such a configuration, it is possible to calculate points in association with an operation device. Accordingly, it is possible to calculate points that are specialized to individual operation devices and, in addition to effects similar to those of the first embodiment and the second embodiment, it is possible to respond to a request by a user to customize an operation device.

### Modifications of Embodiments

The present disclosure is not limited to the embodiments described above, and modifications, improvements, and the like that are within a scope that enables the objective of the present disclosure to be achieved are included in the present disclosure.

The point calculation processes described in the embodiments are examples, and the present disclosure is not limited to these examples. For example, in a case where a plurality of types of points is calculated, configuration may be taken such that it is possible to convert points between one another.

The processes for a point usage time described in the embodiments are examples, and the present disclosure is not limited to these examples. For example, points described in the embodiments described above may be exchanged for various types of points in, inter alia, an existing social game, a mileage service, and a point service.

Configuration may be taken such that some or all of configurations described in the embodiments described above are combined. For example, in the control section 22 in the information processing device 20 in the first embodiment, configuration may be taken to include the functionality of a game execution section similar to that in the second embodiment and the third embodiment, in addition to the character generation section 222, or, in the control section 32 in the information processing device 30 in the second embodiment, configuration may be taken to include the functionality of a character generation section similar to that in the first embodiment and the third embodiment, in addition to the game execution section 322.

In the first embodiment described above, configuration may be taken such that some processing performed by the information processing device 20 is performed by the operation device 10. For example, configuration may be taken such that some or all of the functionality of the calculation section 221 and the character generation section 222 in the information processing device 20 in the first embodiment is performed by the operation device 10. Similarly, configuration may be taken such that some or all of the functionality of the calculation section 321 and the game execution section 322 in the information processing device 30 in the second embodiment is performed by the operation device 10.

In addition, configuration may be taken such that some processing performed by the calculation section 43 in the operation device 40 in the third embodiment is performed by the information processing device 50.

In the embodiments described above, an information processing system provided with an operation device and an information processing device is exemplified. However, there is no limitation to this, and the present disclosure can also be similarly applied to various devices in which an operation device and information processing device are integrated. In addition, the present disclosure can also be similarly applied to a portable terminal such as a smartphone or a tablet.

### Summarization of Present Disclosure

The summarization of the present disclosure is appended in the following.

[1] An information processing device including: at least one memory for storing a program code; and at least one processor for executing an operation by processing the program code, in which the operation includes obtaining information indicating a detection result according to an operation device that includes a detection section that detects an operation by a user, and calculating, on the basis of at least one of a type of the operation, the number of times for the operation, and an amount of execution time for the operation, points to be redeemed by a user.
[2] The information processing device according to [1], in which the type of the operation includes at least one of a type of operation piece used in the operation, an operation direction for the operation piece, and an operation angle for the operation piece.
[3] The information processing device according to [1] or [2], in which the calculating calculates a plurality of types of points that has mutually different intended uses.
[4] The information processing device according to any one of [1] to [3], in which the operation further includes generating a character according to the points.
[5] The information processing device according to [4], in which the generating determines, according to the points, at least one of a shape of the character, the number of the character, and movement details for the character.
[6] The information processing device according to any one of [1] to [5], in which the operation further includes executing a game according to the points.
[7] A system including: an operation device that accepts an operation by a user; and an information processing device, in which the operation device includes at least one memory for storing a program code and at least one processor for execution an operation by processing the program code, the operation including detecting the operation, calculating, on the basis of at least one of a type of the operation, the number of times for the operation, and an amount of execution time for the operation, points to be redeemed by a user, and transmitting information indicating the points to the information processing device.
[8] The system according to [7], in which the operation device is at least one of a controller, a keyboard, a mouse, and a touch panel.
[9] An information processing method performed by an information terminal connected to an operation device that includes a detection section and accepts an operation by a user, by an operation that at least one processor executes according to a program code stored in at least one memory, the method including: obtaining information indicating a detection result by the detection section; and calculating, on the basis of at least one of a type of the operation, the number of times for the operation, and an amount of execution time for the operation, points to be redeemed by a user.
[10] A program executed by an information terminal connected to an operation device that includes a detection section and accepts an operation by a user, in which an operation that at least one processor executes in accordance with the program includes, according to the information terminal, obtaining information indicating a detection result by the detection section; and calculating, on the basis of at least one of a type of the operation, the number of times for the operation, and an amount of execution time for the operation, points to be redeemed by a user.

1. An information processing device comprising:
at least one memory for storing a program code; and
at least one processor for executing an operation by processing the program code, wherein the operation includes
obtaining information indicating a detection result according to an operation device that includes a detection section that detects an operation by a user, and
calculating, on a basis of at least one of a type of the operation, the number of times for the operation, and an amount of execution time for the operation, points to be redeemed by a user.

2. The information processing device according to claim 1, wherein the type of the operation includes at least one of a type of operation piece used in the operation, an operation direction for the operation piece, and an operation angle for the operation piece.

3. The information processing device according to claim 1, wherein the calculating calculates a plurality of types of points that has mutually different intended uses.

4. The information processing device according to claim 1, wherein the operation further includes generating a character according to the points.

5. The information processing device according to claim 4, wherein the generating determines, according to the points, at least one of a shape of the character, the number of the character, and movement details for the character.

6. The information processing device according to claim 1, wherein the operation further includes executing a game according to the points.

7. A system comprising:
an operation device that accepts an operation by a user; and
an information processing device,
wherein the operation device includes at least one memory for storing a program code and at least one processor for execution an operation by processing the program code, the operation including
detecting the operation,
calculating, on a basis of at least one of a type of the operation, the number of times for the operation, and an amount of execution time for the operation, points to be redeemed by a user, and
transmitting information indicating the points to the information processing device.

8. The system according to claim 7, wherein the operation device is at least one of a controller, a keyboard, a mouse, and a touch panel.

9. An information processing method performed by an information terminal connected to an operation device that includes a detection section and accepts an operation by a user, by an operation that at least one processor executes according to a program code stored in at least one memory, the method comprising:
obtaining information indicating a detection result by the detection section; and
calculating, on a basis of at least one of a type of the operation, the number of times for the operation, and an amount of execution time for the operation, points to be redeemed by a user.

10. A non-transitory, computer readable storage medium containing a computer program, which when executed by an information terminal connected to an operation device that includes a detection section and accepts an operation by a user, causes the information terminal to carry out an information processing method, wherein an operation that at least one processor executes in accordance with the program includes, according to the information terminal,
obtaining information indicating a detection result by the detection section; and
calculating, on a basis of at least one of a type of the operation, the number of times for the operation, and an amount of execution time for the operation, points to be redeemed by a user.
